(19) United States
(12) Patent Application Publication
(10) Pub. No.: US 2024/0354190 A1
(43) Pub. Date: Oct. 24, 2024

(54) TECHNIQUES TO USE A MEMORY TAG FOR IN-LINE OR IN-BAND ERROR CORRECTION CODE MEMORY

(71) Applicant: Intel Corporation, Santa Clara, CA (US)

(72) Inventors: Junjing SHI, Nanjing (CN); Wei YANG, Shanghai (CN); Amir Ali RADJAI, Portland, OR (US); Hongjiu LU, San Jose, CA (US)

(21) Appl. No.: 18/759,122

(22) Filed: Jun. 28, 2024

(30) Foreign Application Priority Data
May 7, 2024 (WO) PCT/CN2024/091342

(51) Int. Cl. G06F 11/10

(52) U.S. Cl. CPC G06F 11/1016; G06F 11/1004

(57) ABSTRACT

Examples include techniques associated with use of a memory tag with in-line or in-band error correction code (IBECC) memory to provide protection for data to be stored in an address space of a memory device. Examples include adding or including the memory tag with a single error correction double error detection (SECDED) code based on the data to provide IBECC for the data when stored to the first address space in the memory device.

### CLAIM OF PRIORITY

The present application claims the benefit of priority to Patent Cooperation Treaty (PCT) Application No. PCT/CN2024/091342, filed May 7, 2024, the entire content of which is incorporated herein by reference.

### TECHNICAL FIELD

Examples described herein are generally related to techniques associated with in-line or in-band error correction code memory for data integrity and security for data stored to an address space of a memory device.

### BACKGROUND

A data protection technique that uses error correction code (ECC) memory is a type of data storage that utilizes ECC to detect and correct data corruption to maintain data integrity. In certain systems/applications having a low or no tolerance for errors, ECC memory is used. ECC is one way to add an extra layer of protection in terms of memory reliability. ECC memory can be deployed in workstations and servers using random access memory (RAM). Two examples of ECC memory are out-of-band ECC memory and in-line or in-band ECC memory. Out-of-band ECC memory uses an extra memory chip that is arranged to store parity data that is used to calculate error correction bits. In-band ECC (hereinafter referred to as “IBECC”) memory does not use an extra memory chip, rather ECC code is transmitted in-line or in-band via a memory channel such as a 16/32/64-bit memory channel. For IBECC memory some bits in the memory channel are used to transmit ECC data (e.g., parity bits).

### BRIEF DESCRIPTION OF THE DRAWINGS

FIG. 1 illustrates an example system.

FIG. 2 illustrates an example IBECC scheme.

FIG. 3 illustrates an example IBECC tag format.

FIG. 4 illustrates an example memory-tag for IBECC scheme.

FIG. 5 illustrates an example IBECC agent.

FIG. 6 illustrates an example code.

FIG. 7 illustrates an example first process.

FIG. 8 illustrates an example second process.

FIG. 9 illustrates an example logic flow.

FIG. 10 illustrates an example storage medium.

### DETAILED DESCRIPTION

Kernel address sanitizer (KASAN) is a type of dynamic memory safety error detector designed to find out-of-bands and use-after-free bugs in a Linux kernel. KASAN includes three modes with different technologies: generic, software tag-based, and hardware tag-based. Generic and the software tag-based modes can be commonly referred to as software modes, which have significant performance and memory overheads and can be typically only used for debugging & testing purposes. In some examples, hardware tag-based mode can work on central processing units (CPUs) based on 64-bit reduced instruction set computing (RISC) architectures such as designed by arm®, herein referred to as “arm64 CPUs”. Hardware tag-based mode for arm64 CPUs can be implemented via a memory tagging extension (MTE). Implementation of MTE scheme can have low memory and performance overheads for arm64 CPUs and thus can be used in production. In an example of an implementation of MTE, Armv9 architectures for arm64 CPUs include built in support for MTE as a security feature to detect and attempt to prevent memory safety vulnerabilities before and after deployment of these types of arm64 CPUs.

MTE, as implemented in Armv9 architectures, introduces a notation of two types of tags that include address tags and memory tags. An address-tag is a 4-bit value stored at the top of every pointer in a process. MTE can utilize top-byte-ignore (TBI), a feature of arm64 CPUs that instruct hardware to ignore a topmost byte of memory addresses, allowing this topmost byte to be used as user-controlled metadata. A memory tag can be a 4-bit value associated with every aligned 16-byte region of an application-assigned memory (memory granule). In some examples, arm64 CPUs can be arranged to store a memory-tag in a special meta data space. For these examples, logically, every 16 bytes of application-assigned memory can now contain an extra 4 bits of metadata in addition to 128 bits of data. Also, every time a heap region of application-assigned memory is allocated/assigned, software executed by arm64 CPUs can choose a randomly generated 4-bit tag and can mark both the memory address and newly allocated/assigned memory granules with this 4-bit tag. Load and store instructions can verify that the address-tag matches the memory-tag and can cause a hardware exception on a tag mismatch.

According to some examples, IBECC can allow for single error correction and double error detection (SECDED) with a relatively much lower capacity overhead compared to out-of-band ECC memory. IBECC can also be implemented with no pin count increase as compared to out-of-band ECC memory. Data can be protected at 64-byte or 32-byte granularities, with 2-byte or 4-byte ECC values to provide SECDED. A portion of a memory device's (e.g., a dynamic random access memory (DRAM)) memory capacity can be reserved to store these 2-byte or 4-byte ECC values. As described in this disclosure, a portion of 2-byte or 4-byte ECC values can be arranged as a memory-tag to be used with IBECC that can protect application-assigned memory in a similar manner as mentioned above when MTE is implemented as a security feature with arm64 CPUs.

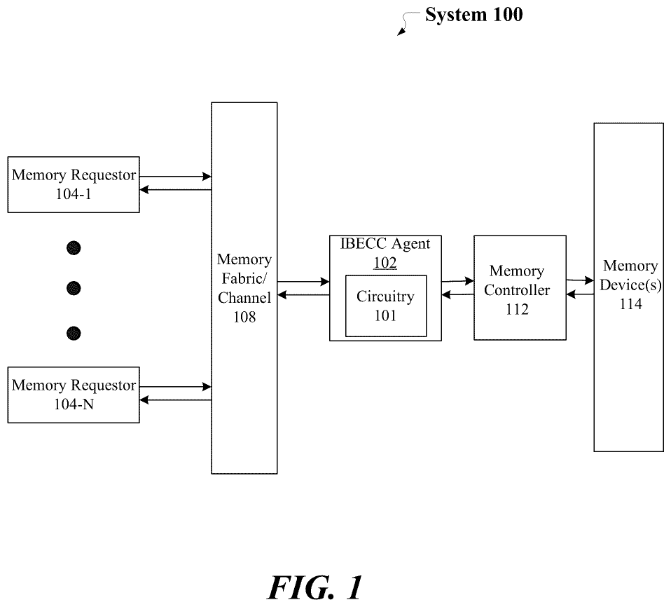

FIG. 1 illustrates an example system 100. According to some examples, as shown in FIG. 1, an in-line or in-band error correction code (IBECC) agent 102 can be placed on a path of memory reads and writes to one or more memory device(s) 114 from memory requestors 104-1 to 104-N, where “N” is any positive whole integer greater than 1. For example, a plurality of memory requestors from among memory requestors 104-1 to 104-N can transmit input/output (I/O) requests that include reads and writes via a memory fabric/channel 108. The plurality of memory requestors, for example, can include applications supported by host computational systems or host computational devices (not shown in FIG. 1).

According to some examples, IBECC agent 102 can be arranged in a configuration such that I/O requests can be intercepted and processed by circuitry 101 at IBECC agent 102 before further processing by a memory controller 112 for accessing memory device(s) 114 that can include, but are not limited to, DRAM memory devices arranged on one or more dual in-line memory modules (DIMMs). While in FIG. 1 IBECC agent 102 is shown as being separate from memory controller 112, in some examples, IBECC agent 102 or its operations can be implemented and/or can be integrated in memory controller 112.

In some examples, as mentioned above, IBECC agent 102 can sit on the path of memory reads and writes routed through memory controller 112 to access memory device(s) 114. Circuitry 101 of IBECC agent 102 can execute or include logic and/or features to protect data associated with the reads and writes at a configurable granularity (e.g., 64-byte or 32-byte), with a 4-byte or 2-byte SECDED code. In other words, IBECC agent 102 sits on the way to memory device(s) 114 and when enabled, intercepts read and write requests routed through memory controller 112. Although IBECC agent 102 can be arranged to support ECC protection of all of a memory address space maintained in memory device(s) 114, it is contemplated that a smaller portion of the memory address space may need to be ECC protected, and critical applications can be allocated that smaller portion of the memory address space. Allocating a smaller portion of the memory address space to critical applications can reduce memory bandwidth overhead when enabling IBECC as accesses to non-ECC protected memory address spaces do not generate additional request to read or write ECC data.

Memory device(s) 114 can include volatile and/or non-volatile types of memory. In some examples, as mentioned above, memory device(s) 114 can be included on one or more DIMMs. The one or more DIMMs can be arranged to include any combination of volatile or non-volatile memory. For these examples, the volatile and/or non-volatile memory included in memory device(s) 114 can be arranged to operate in compliance with one or more of a number of memory technologies described in various standards or specifications, such as DDR3 (double data rate version 3), JESD79-3F, originally released by JEDEC in July 2012, DDR4 (DDR version 4), JESD79-4C, originally published in January 2020, DDR5 (DDR version 5), JESD79-5C, originally published in April 2024, LPDDR3 (Low Power DDR version 3), JESD209-3C, originally published in August 2015, LPDDR4 (LPDDR version 4), JESD209-4D, originally published by in June 2021, LPDDR5 (LPDDR version 5), JESD209-5B, originally published in June 2021, WIO2 (Wide Input/output version 2), JESD229-2, originally published in August 2014, HBM (High Bandwidth Memory), JESD235, originally published in December 2018, HBM2 (HBM version 2), JESD235D, originally published in January 2020, or HBM3 (HBM version 3), JESD238A, originally published in January 2023, or other memory technologies or combinations of memory technologies, as well as technologies based on derivatives or extensions of such above-mentioned specifications. The JEDEC standards or specifications are available at www.jedec.org.

Volatile types of memory may include, but are not limited to, random-access memory (RAM), Dynamic RAM (DRAM), DDR synchronous dynamic RAM (DDR SDRAM), GDDR, HBM, static random-access memory (SRAM), thyristor RAM (T-RAM) or zero-capacitor RAM (Z-RAM). Non-volatile types of memory may include byte or block addressable types of non-volatile memory having a 3-dimensional (3-D) cross-point memory structure that includes, but is not limited to, chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

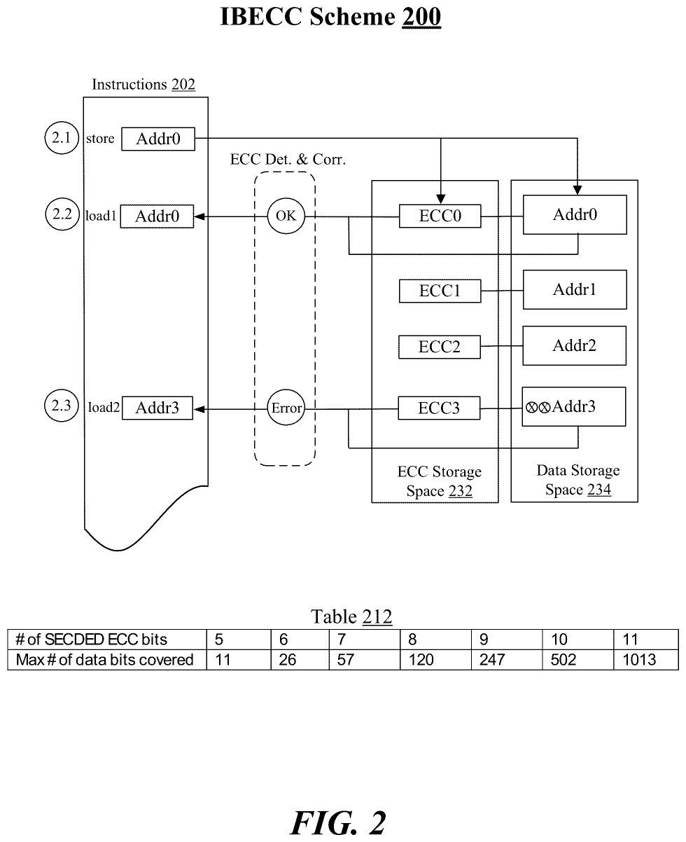

FIG. 2 illustrates an example IBECC scheme 200. In some examples, instructions 202 can be associated with a 32-byte granularity usage example. For these examples, an ECC memory address storage space such as ECC storage space 232 (e.g., maintained in memory device(s) 114) can be reserved or allocated to store ECC meta data that can be separately included in ECC0, ECC1, ECC2 or ECC3. ECC storage space 232 (e.g., maintained in memory device(s) 114) can be arranged to only be accessed by, for example, logic and/or features included in or executed by circuitry 101 of IBECC agent 102 and can be removed as a visual memory address space to, for example, a basic input/output system (BIOS). Meanwhile, data storage space 234 would be arranged to be memory address space that is visible to the BIOS and would also be arranged to store data at memory addresses Addr0, Addr1, Addr2, and Addr3 protected by the meta data included in respective ECC0, ECC1, ECC2 and ECC3.

According to some examples, for every 32 bytes of data (e.g., stored at Addr0, Addr1, Addr2, or Addr3 of data storage space 234) 2 bytes or 16 bits can be allocated to include meta data for use in an SECDED code. Hence, for these examples, ECC0, ECC1, ECC2 and ECC3 can be arranged to separately include 16 bits of meta data. For these examples, at least of portion of the 16 bits can be used to calculate the SECDED code based on, for example, a linear error-correcting code such as, but not limited to, a hamming code. According to table 212 shown in FIG. 2, only 10 of the 16 bits would be needed to protect the 32*8=256 data bits included in each 32-byte/256-bit chunk of data maintained in Addr0, Addr1, Addr2, or Addr3. If 12 of the 16 bits were used to calculate the SECDED code, the extra 2 bits could reduce a risk of silent data corruption (SDC) for each 32-byte/256-bit chunk of data maintained in Addr0, Addr1, Addr2, or Addr3. As will be described in more details below, the remaining 4 bits of the 16 bits of meta data can be arranged to serve as a 4-bit memory tag for memory address safety.

In some examples, as shown in FIG. 2 for IBECC scheme 200, at 2.1, instructions 202 can include having a store command to cause 32 bytes of data to be stored to a target address of Addr0 at data storage space 234. For these examples, logic and/or features included in or executed by circuitry of an IBECC agent such as circuitry 101 of IBECC agent 102 can use an ECC address lookup to determine that the target address of Addr0 is included in a protected data storage space 234. The logic and/or features of the IBECC agent can then calculate an SECDED code to be included in ECC0 using the 32 bytes of data to be stored to Addr0 and then cause ECC0 to be stored to ECC storage space 232. As mentioned above, 12 bits of the 16 bits included in ECC0 can be used for the calculated SECDED code to protect the 32 bytes of data.

According to some examples, at 2.2, instructions 202 having a first load command (load1) can cause the 32 bytes of data to be read from target address Addr0. For these examples, the logic and/or features of the IBECC agent, responsive to the first load command, can be arranged to read the metadata included in ECC0 and the 32 bytes of data at Addr0 and use the SECDED code included in ECC0's meta data to check for data corruption. As shown in FIG. 2, the dash-lined box indicates ECC detection and correction and the circled “OK” indicates that no data corruption was detected (e.g., no bit errors and/or a single bit error that was corrected).

In some examples, at 2.3, instructions 202 having a second load command (load2) can cause 32 bytes of data to be read from target address Addr3 maintained in data storage space 234. For these examples, ECC3 can include a SECDED code in its meta data that is calculated using the 32 bytes of data stored at Addr3. Also, the logic and/or features of the IBECC agent, responsive to the second load command, can be arranged to read the metadata included in ECC3 and the 32 bytes of data at Addr3 and use the SECDED code included in ECC3's meta data to check for data corruption. As shown in FIG. 2, the dash-lined box indicates ECC detection and correction and the circled “Error” indicates that data corruption was detected. Also, the 2 circled X's next to Addr3 shown in FIG. 2 can indicate that 2 errors were detected. Since the SECDED code can correct only a single error, the logic and/or features of the IBECC agent can generate an exception that can cause a memory controller to not load the 32 bytes of data stored at Addr3 due to the detected, yet uncorrected 2 errors. The exception, for example, can cause a memory controller to take additional error correction measures that can correct multiple errors or can flag the 32 bytes of data stored at Addr3 as corrupted and/or uncorrectable. IBECC scheme 200 can then come to an end.

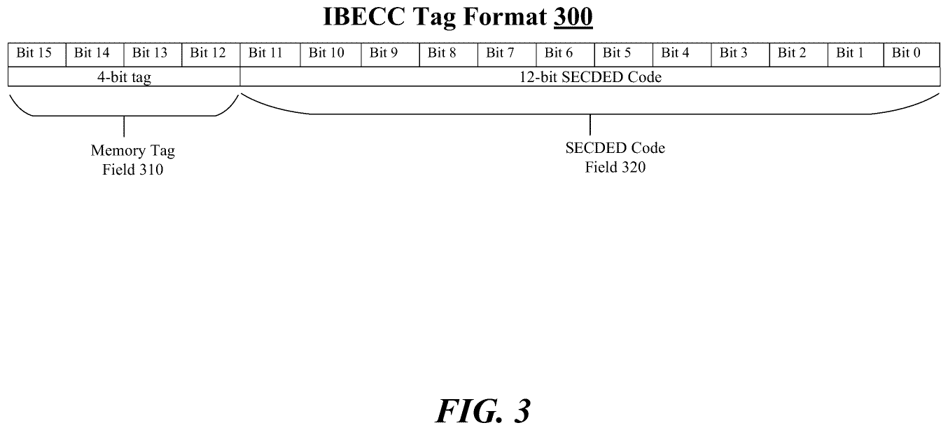

FIG. 3 illustrates an example IBECC tag format 300. According to some examples, as shown in FIG. 3, IBECC tag format 300 includes a total of 16 bits of meta data that have a memory tag field 310 and a SECDED code field 320. Similar to as mentioned above for FIG. 2, the 12 bits included in SECDED code field 320 can include a SECDED code that can be calculated based on 32 bytes of data to be stored to a target address maintained in a protected data space. Also, as briefly mentioned above and described in more detail below, the remaining 4 bits of the 16 bits that is included in memory tag field 310 can be used with IBECC to further protect the 32 bytes of data to be stored to the target address maintained in the protected data space. Examples are not limited to a 16 bit IBECC tag format. For example, 32-bit, 64-bit or even larger bit-sized IBECC tag formats can be used that include at least a 4-bit memory tag field and additional bits to support multiple SECDED code widths that can protect more than 32 bytes of data.

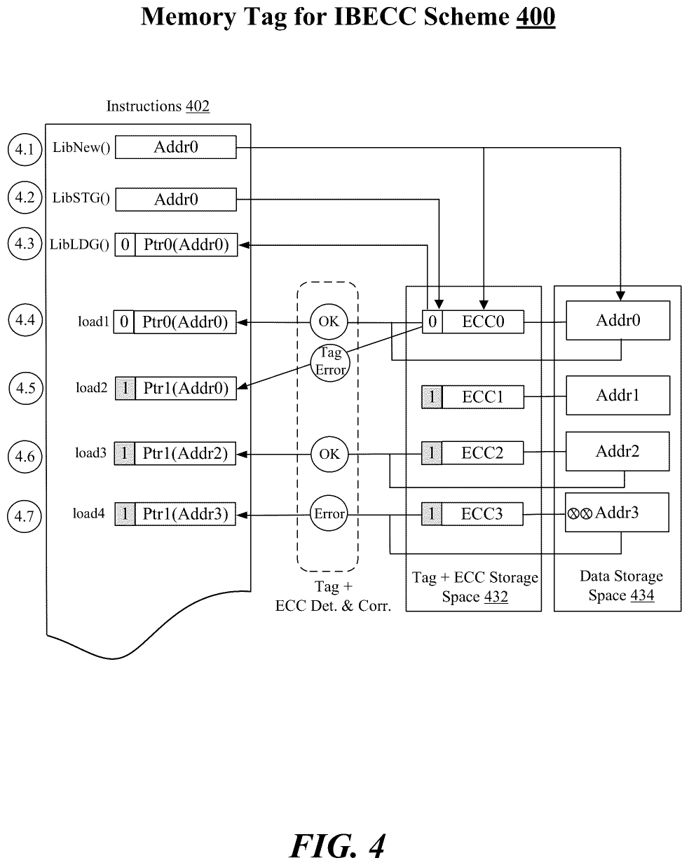

FIG. 4 illustrates an example memory tag for IBECC scheme 400. In some examples, similar to instructions 202 shown in FIG. 2, instructions 402 can be associated with a 32-byte granularity usage example. For these examples, a tag+ECC memory address storage space such as tag+ECC storage space 432 (e.g., maintained in memory device(s) 114) can be reserved or allocated to facilitate two checks in parallel ways. One check is to match a read/write pointer address tag with a memory tag for 32 bytes of data to be accessed from protected data storage space 434 (e.g., maintained in memory device(s) 114) and the other check is for checking the 32 bytes of data for corruption using a SECDED code that can be calculated based on the 32 bytes of data.

In some examples, instructions 402 of memory tag for IBECC scheme 400 can be implemented via register interface or instruction set architecture (ISA) extension to let an OS driver/runtime library manipulate or modify instructions 402. For these examples, an application of a host computational system (e.g., that includes system 100) can invoke a system call or instruct a runtime library to process an address tag and a memory tag as described in more detail below for the steps associated with memory tag for IBECC scheme 400.

According to some examples, at 4.1, instructions 402 having a LibNew( ) command can cause 32 bytes of data to be stored to a target address of Addr0 at data storage space 434. For these examples, logic and/or features included in or executed by circuitry of an IBECC agent such as circuitry 101 of IBECC agent 102 can use an ECC address lookup to determine that the target address of Addr0 is included in a protected data storage space 434. The logic and/or features of the IBECC agent can then calculate an SECDED code to be included in ECC0 using the 32 bytes of data to be stored to Addr0 and then cause ECC0 to be stored to ECC storage space 432. Example IBECC tag format 300 can be used via which the 12 bits included in SECDED code field 320 can be used to maintain the calculated SECDED code in ECC0 to provide SECDED protection to the 32 bytes of data.

In some examples, at 4.2, instructions 402 having a LibSTG( ) command can cause a 4-bit memory tag value to be set for the 32 bytes of data protected by ECC0 based on an address tag value associated with Addr. For example, as shown in FIG. 4, the 4-bit memory tag value could be set to a value of 0. The 4-bit memory tag value can range from a value of 0 to 16. However, examples are not limited to 4-bit memory tag values, larger or smaller values for larger or smaller bit-sized memory tags are contemplated.

According to some examples, at 4.3, instructions 402 having a LibLDG( ) command can cause the memory tag value of 0 to be loaded to tag+ECC storage space 432 with ECC0. For these examples, logic and/or features included in or executed by circuitry of an IBECC agent such as circuitry 101 of IBECC agent 102 can cause a value of 0 to be indicated in the 4 bits included in memory tag field 310 of example IBECC tag format 300 in order to load the memory tag value of 0 to tag+ECC storage space 432 with ECC0. Also, an address tag pointer of 0 (Ptr0) can be set as an address tag for the memory tag value of 0 loaded to tag+ECC storage space 432 with ECC0. The address tag pointer of 0, for example, can be set based on a procedure known as linear address masking (LAM) that can cause hardware such as a memory controller to ignore at least the top four bits of data at a memory address. These top four bits can store data that can serve as an address tag and can be configured to match the memory tag value to indicate that any requestor that requests access to data at a given target address must have a match between the address tag value and the memory tag value. A mismatch can cause an exception and a denial of a request to load data from the given target address.

In some examples, at 4.4, instructions 402 having a first load command (load1) can cause 32 bytes of data to be read from target address Addr at data storage space 434 that also includes an address tag pointer of Ptr0. For these examples, the logic and/or features of the IBECC agent, responsive to the first load command, can be arranged to read the SECDED code included in ECC0 and the 32 bytes of data at Addr0 and use the SECDED code included in ECC0 to conduct a first check for data corruption and to also compare the memory tag value of 0 to the address tag Ptr as part of a second check. As shown in FIG. 4 the dash-lined box indicates tag+ECC detection and correction and the circled “OK” indicates that no data corruption was detected (e.g., no bit errors and/or a single bit error that was corrected) and also indicates that the address tag address tag pointer of 0 (Ptr0) matches the memory tag value of 0.

In some examples, at 4.5, instructions 402 having a second load command (load2) can cause 32 bytes of data to be read from target address Addr0 at data storage space 434 that, for this second load command, also includes an address tag pointer of 1 (Ptr1). For these examples, the logic and/or features of the IBECC agent, responsive to the second load command, can be arranged to read the SECDED code included in ECC0 and the 32 bytes of data at Addr0 and use the SECDED code included in ECC0 to conduct a first check for data corruption and to also compare the memory tag value of 0 to the address tag Ptr0 as part of a second check. As shown in FIG. 4 the dash-lined box indicates tag+ECC detection and correction and the circled “Tag Error” indicates that data corruption was detected based on the second check of the address tag value of Ptr1 not matching the memory tag value of 0. The logic and/or features of the IBECC agent can generate an exception that can cause a memory controller to not load or block the 32 bytes of data from being stored at Addr3 due to the tag mismatch. The exception can cause a memory controller or an OS to take subsequent actions based on an assumption that a security breach for accessing the 32 bytes of data may be indicated by the tag mismatch.

According to some examples, at 4.6, instructions 402 having a third load command (load3) can cause 32 bytes of data to be read from target address Addr2 at data storage space 434 that also includes an address tag pointer of Ptr1. Although not shown in FIG. 4 for instructions 402, ECC2 and its corresponding memory tag value of 1 can be stored to tag+ECC storage space 432 in a similar manner as mentioned above for ECC0 at 4.1 and 4.2. For these examples, the logic and/or features of the IBECC agent, responsive to the third load command, can be arranged to read the SECDED code included in ECC2 and the 32 bytes of data at Addr3 and use the SECDED code included in ECC2 to conduct a first check for data corruption and to also compare the memory tag value of 1 to the address tag Ptr1 as part of a second check. As shown in FIG. 4 the dash-lined box indicates tag+ECC detection and correction and the circled “OK” indicates that no data corruption was detected (e.g., no bit errors and/or a single bit error that was corrected) and the address tag address tag pointer of 1 (Ptr1) matches the memory tag value of 1.

In some examples, at 4.5, instructions 402 having a fourth load command (load4) can cause 32 bytes of data to be read from target address Addr3 at data storage space 434 that, for this fourth load command, also includes an address tag pointer of 1 (Ptr1). Although not shown in FIG. 4 for instructions 402, ECC3 and its corresponding memory tag value of 1 can be stored to tag+ECC storage space 432 in a similar manner as mentioned above for ECC0 at 4.1 and 4.2. For these examples, the logic and/or features of the IBECC agent, responsive to the fourth load command, can be arranged to read the SECDED code included in ECC3 and the 32 bytes of data at Addr3 and use the SECDED code included in ECC3 to conduct a first check for data corruption and to also compare the memory tag value of 1 to the address tag Ptr1 as part of a second check. As shown in FIG. 4 the dash-lined box indicates tag+ECC detection and correction and the circled “Error” indicates that data corruption was detected based on the first check. Also, the 2 circled X's next to Addr3 shown in FIG. 4 can indicate that 2 errors were detected. Since the SECDED code can correct only a single error, the logic and/or features of the IBECC agent can generate an exception that can cause a memory controller to not load the 32 bytes of data stored at Addr3 due to the detected, yet uncorrected 2 errors. The exception, for example, can cause a memory controller to take additional error correction measures that can correct multiple errors or can flag the 32 bytes of data stored at Addr3 as corrupted and/or uncorrectable. Memory tag for IBECC scheme 400 can then come to an end.

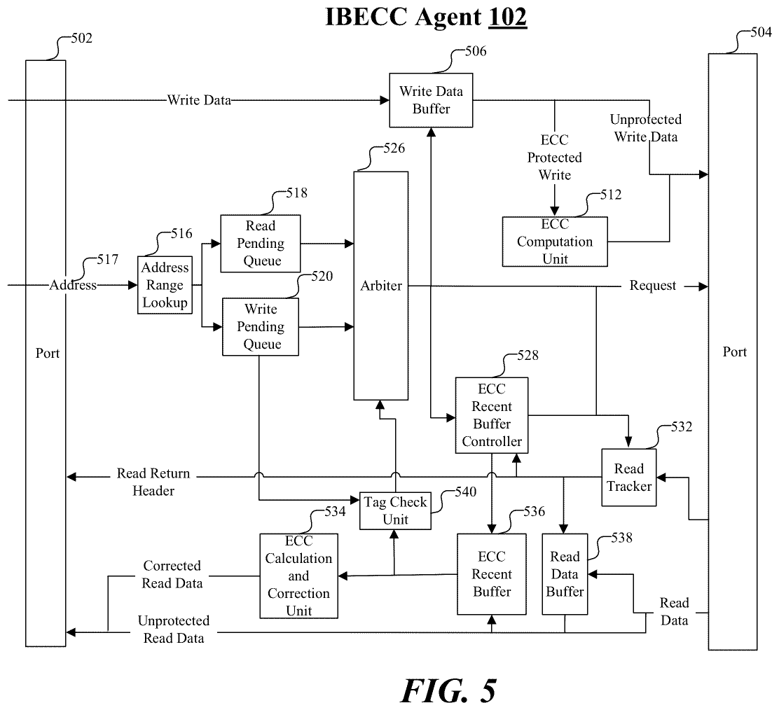

FIG. 5 illustrates an example of IBECC agent 102. According to some examples, FIG. 5 shows a block diagram of elements, logic and/or features in IBECC agent 102. In some examples, these elements, logic and/or features of IBECC agent 102 can be part of or integrated with circuitry 101. Operations performed with the elements, logic and/or features of IBECC agent 102, in some examples, can be performed such that the elements, logic and/or features of IBECC agent 102 behave as both a memory requestor and responder on a path to addressable protected memory maintained in a tag+ECC or data storage space.

According to some examples, as shown in FIG. 5, IBECC agent 102 can include an interface and/or port 502 (e.g., to couple with memory fabric/channel 108), and an interface and/or port 504 (e.g., to couple with memory controller 112), a write data buffer 506, an ECC computation unit 512, an address range lookup 516, a read pending queue 518, a write pending queue 520, an arbiter 526, an ECC recent buffer controller 528, a read tracker 532, a read data buffer 538, an ECC recent buffer 536, an ECC calculation and correction unit 534, or a tag check unit 540.

All reads and writes entering the IBECC agent 102 via port 502 go through an address range lookup 516 that first determines whether the given transaction is an ECC protected access, based on its address 517. Hazard checks are performed and a determination is made of the queue to send the read or write to.

In some examples, IBECC agent 102 can maintain two separate queues 518, 520 for reads and writes. The queues can be combined across ECC and non-ECC traffic. Each queue entry in all the queues can hold information for the data request; the ECC transaction is generated after the request wins the arbitration. The queues also maintain additional meta data to indicate whether the request is an ECC-protected transaction, whether it is currently blocked due to a dependency on another transaction, and other meta data fields to enable scheduling. For these examples, each of the queues can present the oldest, non-blocked transaction to the main in-band ECC module arbiter 526. Arbiter 526 can then select one request at a time based on an arbitration policy.

According to some examples, for each inflight memory tag/ECC-protected read transaction, IBECC agent 102 can track completion of two independent reads: the data read and the memory tag/ECC read. The ECC detection and correction unit 534 can be performed after the data for both read transactions are returned. Moreover, IBECC agent 102 can assign a new request tag to each protected read or write request. ECC read tracker 532 can hold the original read request's tag and tracks the completion of the two associated read requests.

In some examples, read data buffer 538 can consist of separate storage for ECC protected read transactions and unprotected return data.

According to some examples, ECC recent buffer 536 can store the most recently accessed ECC data. Each entry in ECC recent buffer 536 holds the ECC data for 32, 16 or 8 cache lines based on configured protection granularity.

In some examples, once a request enters IBECC agent 102, the address of that transaction can be compared against the protected address ranges to determine whether that request is to an ECC-protected or non-protected region. The request is then allocated into one of the pending request queues.

According to some examples, each of the queues presents the oldest, non-blocked transaction to IBECC agent 102. For these examples, IBECC agent 102 can employ arbiter 526 to schedule at a “transaction” level. For ECC-protected traffic, a transaction can consist of two reads/writes; for unprotected traffic it is just a single read/write. The ECC transaction is generated after the requests are selected by arbiter 526. The ECC data request address can be computed as a function of the incoming address pointing to the ECC data storage region. Once a winner transaction is selected, IBECC agent 102 can ensure that it is atomically issued. This essentially means that if an ECC-protected transaction is selected, then both of the reads/writes to data and the ECC are issued back-to-back, and no other intervening read/write from another transaction can be issued.

In some examples, read data buffer 538 can serve as a temporary storage for all in-flight protected data and their ECC values. Before sending the request, IBECC agent 102 can ensure that there are pre-assigned data return slots in the read data buffer 538 for returning the data and its ECC data. For unprotected traffic, there can be dedicated first in first out (FIFO) data structures.

According to some examples, read tracker 532 can operate in lockstep with ECC recent buffer 536 and keeps header information for the original request, as well as tracking details of when the data is returned and ready to be consumed.

In some examples, requests entering IBECC agent 102 can go through an ECC address lookup to determine whether it is a protected transaction. There can be many types of requests, based on whether it is protected/unprotected and read/full write/partial write.

According to some examples, an unprotected read entering IBECC agent 102 can be directed to read pending queue 518, which supports scheduling based on an age of a transaction. A read address can be checked against write pending queue 520 to see if there are any dependencies with writes waiting in this queue. If there is a match, the newer write can be blocked in the queue until all previous writes to the same address are scheduled. When the read's data returns from the memory controller, IBECC agent 102 can check the tag information to determine whether the data is for protected traffic or unprotected traffic. In the case of unprotected read, the read data bypasses both ECC calculation and correction unit 534 and tag check unit 540 and sent to the original requestor.

In some examples, an unprotected full write transaction entering IBECC agent 102 can be directed to write pending queue 520 that supports scheduling based on age. Arbiter 526 can check the address of the write transaction against other entries in the this queue to see if it has any dependencies with older writes and reads to a same address and gets blocked until dependency is resolved. For an unprotected write and partial write, IBECC agent 102 can behave as a forwarding agent with no ECC generation needed.

According to some examples, similar to unprotected read, on allocation, a protected read transaction can cause a look up in write pending queue 520 to find possible transactions (data/ECC pairs) it may be blocked on. Protected reads can remain blocked until they see both the data and an ECC request to that address go out from a scheduler. For these examples, once a read request wins an arbitration, ECC recent buffer 536 can be checked to see whether ECC data for that associated ECC request already exists in ECC recent buffer 536. On a miss, a new entry is allocated in the ECC recent buffer 536 when the buffer is not full, or if the ECC recent buffer 536 is full, one of the entries in the ECC recent buffer 536 with no waiting consumers cab be deallocated and a new entry can be allocated in that location. An entry number for this transaction can be stored in read tracker 532. Also, an ECC data transaction can be generated in parallel and can be sent immediately after the read data request. On a hit, ECC recent buffer controller 528 can increment a consumer counter of an entry and also returns an entry number in ECC recent buffer 536 to indicate where ECC data is stored. This entry number can be stored in read tracker 532 and can be utilized when the corresponding ECC data is present in the ECC recent buffer 536. In this case the ECC data transaction is not generated since ECC recent buffer 536 will have the ECC data ready. On a return path, IBECC agent 102 can wait for both the data access and ECC access (if not present in ECC recent buffer 536) to return before performing ECC detection/correction operations. Readiness of the needed ECC data can be tracked by read tracker 532. IBECC 102 needs to ensure that there are slots in read data buffer 538/read tracker 532 such that returning transactions can be held before being issued to ECC calculation and correction unit 534. In order to address this issue, IBECC agent 102 can pre-allocate an entry in read tracker 532 at the point of scheduling. When a protected read data returns, IBECC agent 102 can identify at which location in the read data buffer 538 it should be written. When the ECC data returns to IBECC agent 102, ECC recent buffer 536, an entry number can be broadcast to all the waiting consumers tracked by read tracker 532 and the entry number will enable a check of whether that entry number is equal to an entry number a given consumer is waiting for and therefore be able to track when the ECC data has arrived and is ready for consumption from ECC recent buffer 536. Once both accesses are in read data buffer 538 and ECC recent buffer 536, IBECC agent 102 can schedule a request to ECC calculation and correction unit 534. Corrected data can then be placed in an appropriate first in first out (FIFO) queue (not shown) and sent to the requestor.

In some examples, when a protected write transaction enters IBECC agent 102, associated request information can be allocated in write pending queue 530, and the data is stored in write data buffer 506. For these examples, ECC request address, value, and byte enabled for a protected write are not stored but are generated on the fly, when the transaction is scheduled. IBECC agent 102 needs to ensure write-after-write and write-after-read ordering as well as invalidation of the corresponding ECC data in ECC recent buffer 536 if present. To ensure this, an incoming write request can cause a check against reads in pending read queue 518, outstanding reads waiting in read tracker 532/read data buffer 538, and valid entries in ECC recent buffer 536.

According to some examples, a protected partial write transaction handled by IBECC agent 102 can essentially be composed of two protected transactions: A protected underfill read transaction and a protected full write transaction. Hazard management can be the same as the full write case. Note, however, that underfill read transaction cannot be issued without all of the hazards and dependencies clearing. IBECC agent 102 may need to be aware that it is issuing an underfill read, and tracker/read data buffer structures may need to set the underfill field, as well as indicate which entry in the write queue is the recipient of the underfill read. Once the underfill read is complete, the corrected data can be directed back to write data buffer 506, where it can be merged with the partial data. After this point, write pending queue can now present a protected full write to be handled by IBECC agent 102.

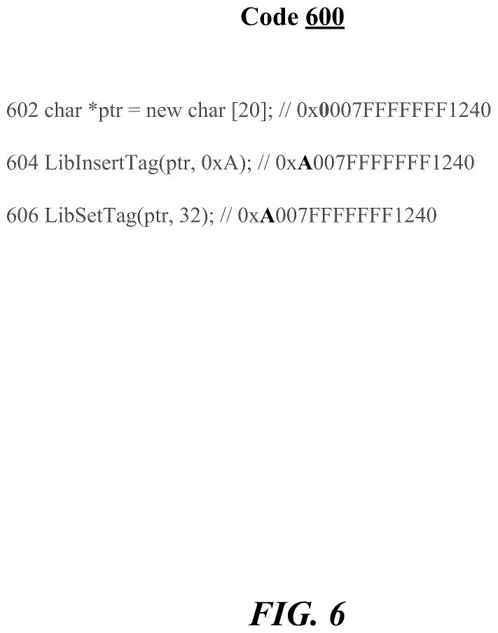

FIG. 6 illustrates an example code 600. According to some examples, code 600 can represent an example operation code (OpCode) to initiate implementation of a memory tag process for use with IBECC. As described in more detail below, code 600 can be used to support a tag read/write request associated with memory tag management that includes storing and loading memory tags for use with IBECC. This tag read/write request can be to explicitly set or load tag values to a tag+ECC storage space (e.g., maintained in memory device(s) 114). A tag read/write request can join arbitration with other read/write transactions routed through an IBECC agent such as IBECC agent 102 mentioned above in for FIG. 5. The tag read/write request to join arbitration with other read/write transactions can ensure it is legal to send a request by a requestor (e.g., an OS agent) to a reserved tag+ECC storage space. This tag read/write request can be implemented with an existing data request and use an especial request OpCode such as example code 600 to distinguish tag+ECC storage space and a visible data storage space.

According to some examples, code 600, at 602, indicates new data “new char [20] is to be stored to a protected memory access at an address included in a visible data storage space. As shown in FIG. 6, the address is indicated as 0x0007FFFFFFF1240. Then, at 604, linear address masking (LAM) can be used to set an address tag pointer via a “Lib InsertTag(ptr, 0xA) to indicate that the address tag pointer of “0xA” is to be set for this address. For example, the bolded “A” of 0xA007FFFFFFF1240 indicates the setting of the address tag pointer of “0xA” via use of LAM. Then, at 606, a “LibSetTag(ptr, 32) indicates a setting of a memory tag of “0xA” for a 32 byte buffer at address 0x0007FFFFFFF1240 of the visible data storage space. As mentioned above for IBECC tag format 300 this memory tag value of “0xA” can be indicated in memory tag field 310 and SECDED code to protect the data to be stored to 0x0007FFFFFFF1240 can be included in SECDED code field 320.

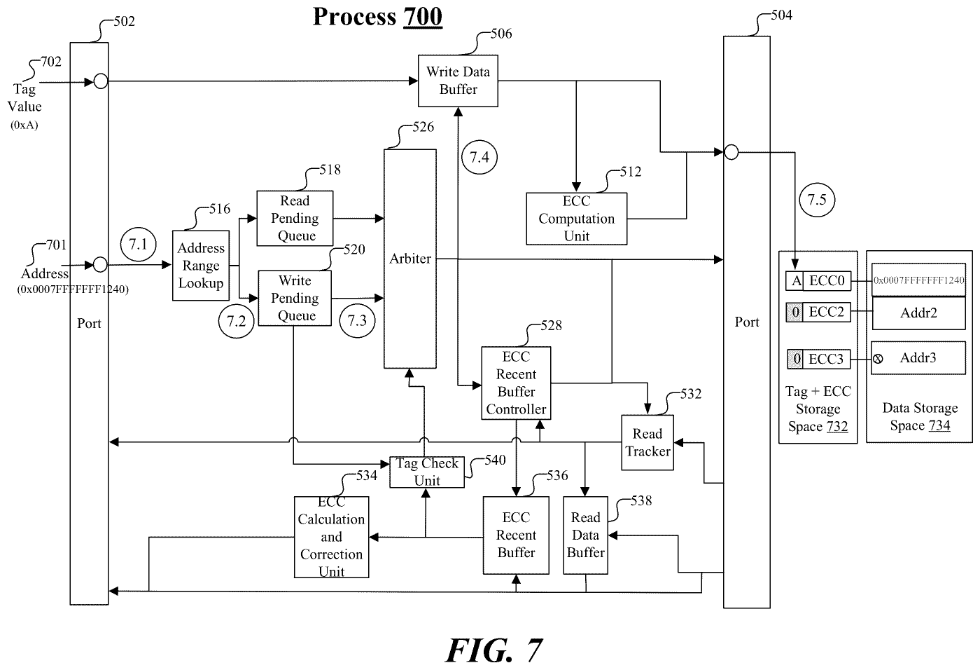

FIG. 7 illustrates an example process 700. According to some examples, process 700 can be implemented by components of IBECC agent 102 as mentioned above for FIGS. 1-2 and 4-5. For these examples, process 700 can be initiated in response to an especial request OpCode such as example code 600. For example, at 7.1, the especial request can be sent to IBECC agent 102 to store memory tag/ECC protected data to memory address 0x0007FFFFFFF1240 maintained at data storage space 734 (e.g., maintained in memory device(s) 114). Address 701 in FIG. 7 indicates how elements of IBECC agent 102 initiate this process. Then, at 7.2, a tag store request is added to write pending queue 520 of IBECC agent 102. Write pending queue 520, for example, can be configured to know that this tag store request is to store a memory tag to tag+ECC storage space 732 (e.g., maintained in memory device(s) 114) and, at 7.3, to directly forward the tag store request to arbiter 526. Then, at 7.4, after the tag store request gets or obtains a priority for arbiter 526, then arbiter 526 causes write data buffer 506 to get or receive the memory tag value of 0xA via tag value 702 routed through interface and/or port 502 of IBECC agent 102. Process 700 then comes to an end at 7.5, where the memory tag value of 0xA is included with ECC0 at tag+ECC storage space 732. The memory tag value and ECC0 can protect data stored to address 0x0007FFFFFFF1240 maintained in data storage space 734.

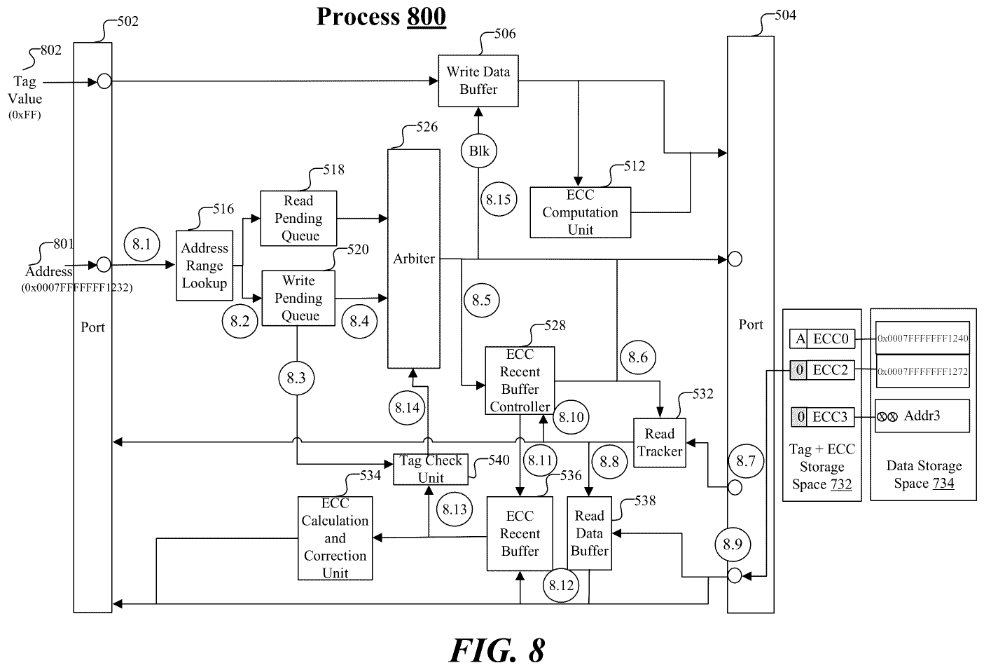

FIG. 8 illustrates an example process 800. According to some examples, process 800 can also be implemented by components of IBECC agent 102 as mentioned above for FIGS. 1-2 and 4-5. For these examples, process 800 can be initiated in response to a normal store request to IBECC agent 102. For example, as shown in FIG. 8, at 8.1, a store request can be to an address 801 that points to address 0x0007FFFFFFF1272 at data storage space 734 (e.g., maintained in memory device(s) 114). Address 0x007FFFFFF1272 can be a LAM address that uses the “0x0” portion of address 801 as an address tag. Then, at 8.2, the store request can be added to write pending queue 520 of IBECC agent 102. Then, at 8.3, write pending queue 520 can identify the request as a normal store request to data storage space 734 with a LAM address that indicates a memory tag of 0xA that is provided to tag check unit 540. Then, at 8.4, write pending queue 520 can also forward the store request to arbiter 526. Then, at 8.5, once the store request receives or gets priority this can cause arbiter 526 to check with ECC recent buffer controller 528 to determine whether ECC recent buffer 536 contains ECC meta data for ECC2 for address 0x000FFFFFFF1272 at data storage space 734. The ECC meta data for ECC2, for example, can be in the format of IBECC tag format 300 that includes a 4-bit memory tag field and a 12-bit SECDED code field. Then, at 8.6, responsive to ECC recent buffer 536 not having ECC2, arbiter 526 sends a request to read tracker 532 to retrieve ECC meta data for ECC2 from tag+ECC storage space 732 (e.g., maintained in memory device(s) 114). Then, at 8.7, read tracker 532 receives the request to retrieve the ECC meta data for ECC2 from tag+ECC storage space 732. Then, at 8.8, read tracker 532 places a request to read data buffer 538 to read the ECC meta data for ECC2 at tag+ECC storage space 732 (e.g., maintained in a buffer at memory device(s) 114). Then, at 8.9, read data buffer 538 reads the ECC meta data for ECC2. Then, at 8.10, read tracker 532 monitors read data buffer 538 and notifies ECC recent buffer controller 528 when the ECC meta data for ECC2 is available. Then, at 8.11, responsive to the notification from read tracker 532, ECC recent buffer controller 528 requests that ECC recent buffer 536 read the ECC meta data for ECC2 from read data buffer 538. Then, at 8.12, responsive to the request from ECC recent buffer controller 528, ECC recent buffer reads the ECC meta data for ECC2 from read data buffer 538. The ECC meta data for ECC2, as mentioned at 8.6, includes a 4-bit memory tag field and a 12-bit SECDED code field. Then, at 8.13, the 4-bit memory tag field included in the ECC meta data for ECC2 is sent to tag check unit 540. As shown in FIG. 8, the memory tag included in the ECC meta data for ECC2 is 0 or 0x0. Then, at 8.14, tag check unit 540 compares the address tag of 0xA received at 8.3 from write pending queue 520 with the memory tag of 0x0 and based on the address tag of 0xA not matching the memory tag of 0x0, a message is sent to arbiter 526 to block the store request that was received at 8.2 and was stored in write data buffer 506. Blocking the store request can include causing the store request to be ejected or overwritten from write data buffer 506. Process 800 then comes to an end.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware examples, a logic flow can be implemented by computer executable instructions stored on at least one non-transitory computer readable medium or machine readable medium, such as an optical, magnetic or semiconductor storage. The examples are not limited in this context.

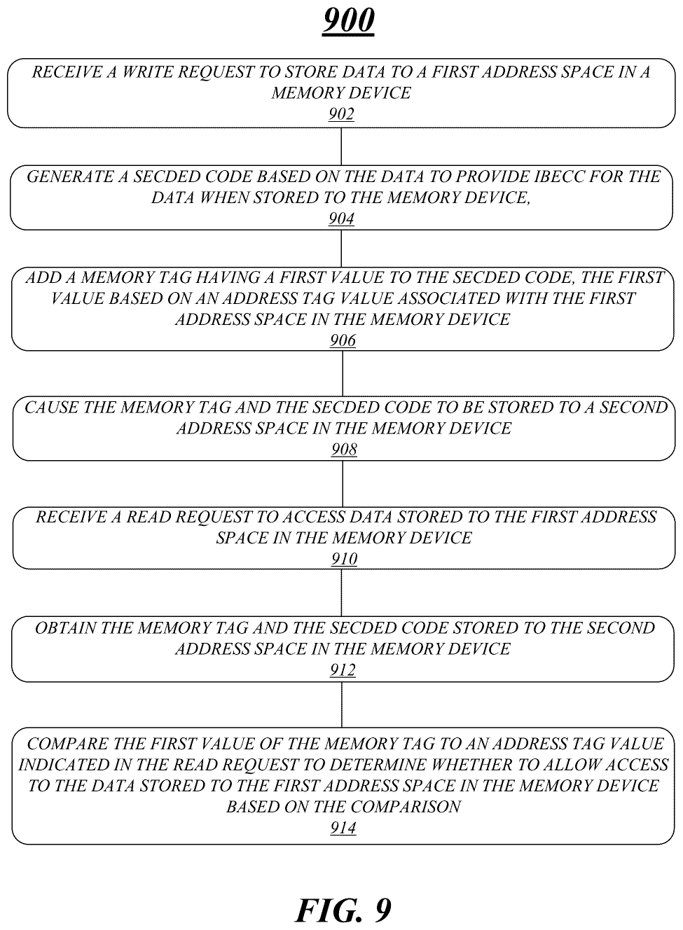

FIG. 9 illustrates an example logic flow 900. Logic flow 900 can be representative of some or all of the operations executed by one or more logic, features, or devices described herein, such as logic and/or features of supported by circuitry 101 included in IBECC agent 102. For example, components of IBECC agent 102 as shown and described for FIG. 1, 5, or 7-8.

In some examples, as shown in FIG. 9, logic flow 900 at block 902 can receive a write request to store data to a first address space in a memory device. For these examples, the write request can be received by circuitry 101 of IBECC agent 102 through a first interface and/or port coupled with a memory fabric/channel such as through interface and/or port 502 shown in FIG. 5 that can be arranged to couple with memory fabric/channel 108. The first address space in the memory device, for example, can be data storage space 734 in memory device(s) 114.

According to some examples, as shown in FIG. 9, logic flow 900 at block 904 can generate a SECDED code based on the data to provide IBECC for the data when stored to the memory device. For these examples, the SECDED code can be a hamming code to provide IBECC for 32 bytes of data to be stored to the first address space in the memory device.

In some examples, as shown in FIG. 9, logic flow 900 at block 906 can add a memory tag having a first value to the SECDED code, the first value based on an address tag value associated with the first address space in the memory device. For these examples, the memory tag and SECDED code can be in example IBECC tag format 300 that, as shown in FIG. 3, includes a 4-bit memory tag field 310 to maintain the first value for the address tag and a 12-bit SECDED code field 320 to maintain the SECDED code.

According to some examples, as shown in FIG. 9, logic flow 900 at block 908 can cause the memory tag and the SECDED code to be stored to a second address space in the memory device. For these examples, the memory tag and SECDED code can be stored to, for example, tag+ECC storage space 732 in memory device(s) 114. Also, port 504 can couple to a memory controller such as memory controller 112 to enable access to memory device(s) 114 to cause the memory tag and SECDED code to be stored to tag+ECC storage space 732.

In some examples, as shown in FIG. 9, logic flow 900 at block 910 can receive a read request to access data stored to the first address space in the memory device. For these examples, the read request can also be received by circuitry 101 of IBECC agent 102 through interface and/or port 502 coupled with memory fabric/channel 108.

According to some examples, as shown in FIG. 9, logic flow 900 at block 912 can obtain the memory tag and the SECDED code stored to the second address space in the memory device. For these examples, circuitry 101 of IBECC agent 102 can obtain the memory tag and SECDED code from tag+ECC storage space 732 at memory device(s) 114 through port 504 coupled with memory controller 112.

In some examples, as shown in FIG. 9, logic flow 900 at block 914 can compare the first value of the memory tag to an address tag value indicated in the read request to determine whether to allow access to the data stored to the first address space in the memory device based on the comparison. For these examples, if circuitry 101 of IBECC agent 102 determines that the first value of the memory tag does not match the address tag value, access to the data stored to the first address space in data storage space 734 is blocked.

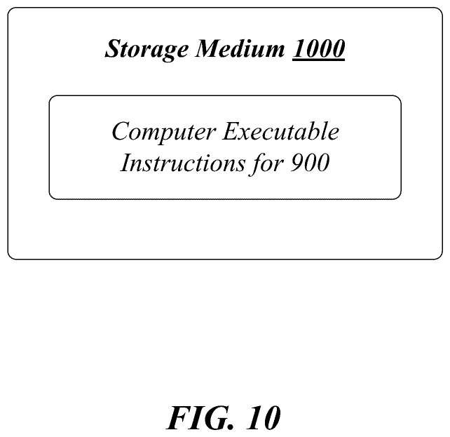

FIG. 10 illustrates an example of a storage medium. As shown in FIG. 10, the storage medium includes a storage medium 1000. The storage medium 1000 may comprise an article of manufacture. In some examples, storage medium 1000 can include any non-transitory computer readable medium or machine readable medium, such as an optical, magnetic or semiconductor storage. Storage medium 1000 can store various types of computer executable instructions, such as instructions to implement logic flow 900. Examples of a computer readable or machine readable storage medium can include any tangible media capable of storing electronic data, including volatile memory or non-volatile memory, removable or non-removable memory, erasable or non-erasable memory, writeable or re-writeable memory, and so forth. Examples of computer executable instructions can include any suitable type of code, such as source code, compiled code, interpreted code, executable code, static code, dynamic code, object-oriented code, visual code, and the like. The examples are not limited in this context.

One or more aspects of at least one example can be implemented by representative instructions stored on a machine-readable medium which represents various logic within the processor, which when read by a machine causes the machine to fabricate logic to perform the techniques described herein. Such representations, known as “IP cores” can be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter can be used to convert an instruction from a source instruction set to a target instruction set. For example, the instruction converter can translate (e.g., using static binary translation, dynamic binary translation including dynamic compilation), morph, emulate, or otherwise convert an instruction to one or more other instructions to be processed by the core. The instruction converter can be implemented in software, hardware, firmware, or a combination thereof. The instruction converter may be on processor, off processor, or part on and part off processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

Example 1. An example apparatus can include a first interface configured to couple with a memory channel and a second interface configured to couple with a memory controller for a memory device. The circuitry can be configured to, responsive to a write request to store data to a first address space in the memory device, generate an SECDED code based on the data to IBECC for the data when stored to the first address space in the memory device. The circuitry can also be configured to include a memory tag having a first value with the SECDED code, the first value based on an address tag value associated with the first address space. The circuitry can also be configured to cause the memory tag and the SECDED code to be stored to a second address space in the memory device.

Example 2. The apparatus of example 1, the circuitry can be further configured to, responsive to a read request to access data stored to the first address space, obtain the memory tag and the SECDED code stored to the second address space. The circuitry can also be configured to compare the first value of the memory tag to an address tag value indicated in the read request to determine whether to allow access to the data stored to the first address space based on the comparison.

Example 3. The apparatus of example 2, the circuitry can be further configured to block access to the data stored to the first address space based on the first value of the memory tag not matching the address tag value.

Example 4. The apparatus of example 2, the write request and the read request can be received via the first interface coupled with the memory channel and the memory tag and SECDED code can be stored to or obtained from the second address space via the second interface coupled with the memory controller.

Example 5. The apparatus of example 1, the memory tag and the SECDED code can be 16 bits that includes a 4-bit memory tag and a 12-bit SECDED code.

Example 6. The apparatus of example 5, the 12-bit SECDED code can be a hamming code to provide IBECC for 32 bytes of data to be stored to the first address space in the memory device.

Example 7. The apparatus of example 1, the memory device can include DRAM.

Example 8. An example method can include receiving a write request to store data to a first address space in a memory device. The method can also include generating an SECDED code based on the data to provide IBECC for the data when stored to the memory device. The method can also include adding a memory tag having a first value to the SECDED code, the first value based on an address tag value associated with the first address space in the memory device. The method can also include causing the memory tag and the SECDED code to be stored to a second address space in the memory device.

Example 9. The method of example 8 can also include receiving a read request to access data stored to the first address space in the memory device. The method can also include obtaining the memory tag and the SECDED code stored to the second address space in the memory device. The method can also include comparing the first value of the memory tag to an address tag value indicated in the read request to determine whether to allow access to the data stored to the first address space in the memory device based on the comparison.

Example 10. The method of example 9 can also include blocking access to the data stored to the first address space based on the first value of the memory tag not matching the address tag value.

Example 11. The method of example 8, the memory tag and the SECDED code can be 16 bits that includes a 4-bit memory tag and a 12-bit SECDED code.

Example 12. The method of example 11, the 12-bit SECDED code can be a hamming code to provide IBECC for 32 bytes of data to be stored to the first address space in the memory device.

Example 13. The method of example 8, wherein the memory device can include DRAM.

Example 14. An example at least one machine readable medium can include a plurality of instructions that in response to being executed by an circuitry coupled to a memory channel via a first interface and coupled to a memory controller for a memory device via a second interface, can cause the circuitry to, responsive to a write request to store data to a first address space in the memory device, generate an SECDED code based on the data to provide IBECC for the data when stored to the memory device. The instructions can also cause the circuitry to include a memory tag having a first value with the SECDED code, the first value based on an address tag value associated with the first address space. The instructions can also cause the circuitry to cause the memory tag and the SECDED code to be stored to a second address space in the memory device.

Example 15. The at least one machine readable medium of example 14, the instructions to can further cause the circuitry to, responsive to a read request to access data stored to the first address space, obtain the memory tag and the SECDED code stored to the second address space. The instructions can also cause the circuitry to compare the first value of the memory tag to an address tag value indicated in the read request. The instructions can also cause the circuitry to determine whether to allow access to the data stored to the first address space based on the comparison.

Example 16. The at least one machine readable medium of example 15, the instructions can further cause the circuitry to block access to the data stored to the first address space based on the first value of the memory tag not matching the address tag value.

Example 17. The at least one machine readable medium of example 15, the write request and the read request can be received via the first interface coupled with the memory channel and the memory tag and SECDED code can be stored to or obtained from the second address space via the second interface coupled with the memory controller.

Example 18. The at least one machine readable medium of example 15, the memory tag and the SECDED code can be 16 bits that includes a 4-bit memory tag and a 12-bit SECDED code.

Example 19. The at least one machine readable medium of example 18, wherein the 12-bit SECDED code can be a hamming code to provide IBECC for 32 bytes of data to be stored to the first address space in the memory device.

Example 20. The at least one machine readable medium of example 15, wherein the memory device can include DRAM.

It is emphasized that the Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a first interface configured to couple with a memory channel; and
a second interface configured to couple with a memory controller for a memory device; and
circuitry configured to:
responsive to a write request to store data to a first address space in the memory device, generate a single error correction double error detection (SECDED) code based on the data to provide in-band error correction code (IBECC) for the data when stored to the first address space in the memory device;
include a memory tag having a first value with the SECDED code, the first value based on an address tag value associated with the first address space; and
cause the memory tag and the SECDED code to be stored to a second address space in the memory device.

2. The apparatus of claim 1, the circuitry further configured to:
responsive to a read request to access data stored to the first address space, obtain the memory tag and the SECDED code stored to the second address space; and
compare the first value of the memory tag to an address tag value indicated in the read request to determine whether to allow access to the data stored to the first address space based on the comparison.

3. The apparatus of claim 2, the circuitry further configured to:
block access to the data stored to the first address space based on the first value of the memory tag not matching the address tag value.

4. The apparatus of claim 2, wherein the write request and the read request are received via the first interface coupled with the memory channel and the memory tag and SECDED code are stored to or obtained from the second address space via the second interface coupled with the memory controller.

5. The apparatus of claim 1, wherein the memory tag and the SECDED code comprise 16 bits that includes a 4-bit memory tag and a 12-bit SECDED code.

6. The apparatus of claim 5, wherein the 12-bit SECDED code comprises a hamming code to provide IBECC for 32 bytes of data to be stored to the first address space in the memory device.

7. The apparatus of claim 1, wherein the memory device includes dynamic random access memory (DRAM).

8. A method comprising:
receiving a write request to store data to a first address space in a memory device;
generating a single error correction double error detection (SECDED) code based on the data to provide in-band error correction code (IBECC) for the data when stored to the memory device;
adding a memory tag having a first value to the SECDED code, the first value based on an address tag value associated with the first address space in the memory device; and
causing the memory tag and the SECDED code to be stored to a second address space in the memory device.

9. The method of claim 8, further comprising:
receiving a read request to access data stored to the first address space in the memory device;
obtaining the memory tag and the SECDED code stored to the second address space in the memory device; and
comparing the first value of the memory tag to an address tag value indicated in the read request to determine whether to allow access to the data stored to the first address space in the memory device based on the comparison.

10. The method of claim 9, further comprising:
blocking access to the data stored to the first address space based on the first value of the memory tag not matching the address tag value.

11. The method of claim 8, wherein the memory tag and the SECDED code comprise 16 bits that includes a 4-bit memory tag and a 12-bit SECDED code.

12. The method of claim 11, wherein the 12-bit SECDED code comprises a hamming code to provide IBECC for 32 bytes of data to be stored to the first address space in the memory device.

13. The method of claim 8, wherein the memory device includes dynamic random access memory (DRAM).

14. At least one machine readable medium comprising a plurality of instructions that in response to being executed by an circuitry coupled to a memory channel via a first interface and coupled to a memory controller for a memory device via a second interface, causes the circuitry to:
responsive to a write request to store data to a first address space in the memory device, generate a single error correction double error detection (SECDED) code based on the data to provide in-band error correction code (IBECC) for the data when stored to the memory device;
include a memory tag having a first value with the SECDED code, the first value based on an address tag value associated with the first address space; and
cause the memory tag and the SECDED code to be stored to a second address space in the memory device.

15. The at least one machine readable medium of claim 14, the instructions to further cause the circuitry to:
responsive to a read request to access data stored to the first address space, obtain the memory tag and the SECDED code stored to the second address space;
compare the first value of the memory tag to an address tag value indicated in the read request; and
determine whether to allow access to the data stored to the first address space based on the comparison.

16. The at least one machine readable medium of claim 15, the instructions to further cause the circuitry to:
block access to the data stored to the first address space based on the first value of the memory tag not matching the address tag value.

17. The at least one machine readable medium of claim 15, wherein the write request and the read request are received via the first interface coupled with the memory channel and the memory tag and SECDED code are stored to or obtained from the second address space via the second interface coupled with the memory controller.

18. The at least one machine readable medium of claim 15, wherein the memory tag and the SECDED code comprise 16 bits that includes a 4-bit memory tag and a 12-bit SECDED code.

19. The at least one machine readable medium of claim 18, wherein the 12-bit SECDED code comprises a hamming code to provide IBECC for 32 bytes of data to be stored to the first address space in the memory device.

20. The at least one machine readable medium of claim 15, wherein the memory device includes dynamic random access memory (DRAM).
